(19) United States
(12) Patent Application Publication
(10) Pub. No.: US 2014/0070579 A1
(43) Pub. Date: Mar. 13, 2014

(54) Fastening tape for seat pad and seat pad having the sam

(71) Applicant: ILKWANG Industry Co., Ltd., Ulsan (KR)

(72) Inventor: Won Woo Lee, Ulsan (KR)

(21) Appl. No.: 13/939,395

(22) Filed: Jul. 11, 2013

(30) Foreign Application Priority Data
Sep. 10, 2012 (KR) 10-2012-0100160

(51) Int. Cl. A44B 18/00; B60N 2/58

(52) U.S. Cl. CPC A44B 18/0073; B60N 2/5833
USPC 297/219.1; 24/306

(57) ABSTRACT

The present invention relates to a fastening tape for a seat pad and a seat pad provided with the fastening tape, and the fastening tape for a seat pad attaching a seat cover to an outside of the seat pad, comprises: a holding sheet on one side of which a plurality of hooks to be connected to loops that are formed inside the seat cover are formed; and a connection member to be connected to the other side of the holding sheet for connecting the holding sheet to the seat pad, wherein the connection member comprises a connection portion that is connected to the holding sheet and provided with a plurality of ring portions, and a mesh portion that is connected to the ring portion, such that a gas produced when urethane is foamed to form the seat pad is discharged through the mesh portion and the ring portion.

### CROSS-REFERENCE TO RELATED APPLICATION

This application is based on and claims priority from Korean Patent Application No. 10-2012-0100160, filed on Sep. 10, 2012 in the Korean Intellectual Property Office, the disclosure of which is incorporated herein in its entirety by reference.

### BACKGROUND OF THE INVENTION

1. Field of the Invention

The present invention relates to a fastening tape for a seat pad and a seat pad provided with the fastening tape, and more particularly, to a fastening tape for a seat pad and a seat pad provided with the fastening tape, which is used for attaching a seat cover on a seat pad arranged on a chair of a vehicle, etc.

2. Description of the Related Art

In general, a seat for a vehicle that is arranged inside a vehicle is composed of a foamed-seat pad with cushion force and a seat cover that covers an outside of the seat pad.

With respect to the seat for a vehicle, there is a drawback that the seat cover surrounding the seat pad is twisted in accordance with a movement of a user when the seat cover surrounding the seat pad is not fixed firmly to a rear of the seat pad since the user frequently seats on and leaves from the seat and further the user moves frequently while he/she is seating on the seat.

In order to overcome the drawback, according to a related art, a seat pad and a seat cover are attached using a wire and a clip, or a Velcro tape.

With respect to the way of attaching the seat pad and the seat cover with a wire and a clip, a wire is arranged to the inside of a non-woven fabric constituting the seat cover and a wire is arranged to one side of an outer surface of the seat pad, corresponding to the location of the wire arranged to the seat cover, and the wire of the seat cover and the wire of the seat pad are fixed through a clip with overlaying the seat cover on the seat pad.

However, in the way of attaching the seat pad and the seat cover using a wire and a clip it is very difficult and takes much time to fix them with overlaying the seat cover on the seat pad. Specially, when the wire is fastened to the clip using a fastening tool with hands, wrist pain is caused from the fastening tool that is heavy, when it is used for a long time, thereby to decrease an efficiency of the fastening.

In the way of attaching the seat pad and the seat cover using a Velcro tape, a seat cover is fixed to a seat pad using the Velcro tape in order to attach the seat cover when the seat cover is formed wherein the Velcro tape is inserted in a frame arranged in a mold, and then urethane resin is introduced and foamed to form the seat pad with the Velcro tape being fixed thereto. However, in this case, the urethane resin is not bonded easily on a rear of a hook substrate of the Velcro tape so that the Velcro tape is not to be fixed firmly to the seat pad after the urethane resin is foam-formed.

In order to solve the above drawbacks, there has been proposed a technology that a non-woven fabric made of urethane is bonded to a rear of the hook substrate and then a Velcro tape is inserted into a frame arranged on a mold and the urethane resin is introduced and foam-formed to manufacture a seat pad with the Velcro tape being fixed thereto, when the seat pad is formed.

However, in the technology as described above, the gas that is produced when the urethane resin is foam-formed is not discharged outside and remains therein, and thus a gap between the non-woven fabric and the seat pad is produced due to the gas that remains inside the non-woven fabric when the formation is completed, thereby to decrease a bonding force between the non-woven fabric and the seat pad and thus the Velcro tape is not to be fixed firmly to the seat pad and peeled off by a small external force.

### SUMMARY OF THE INVENTION

The present invention has been proposed to solve the above drawbacks and one object of the present invention is to provide a fastening tape for a seat pad and a seat pad provided with the fastening tape, in which the fastening tape is bonded to the seat pad to attach the seat cover to the seat pad wherein a decreasing of a bonding force between the seat pad and the fastening tape, which is caused from a gap that is formed therebetween by a gas produced when a urethane resin is introduced and foam-formed, can be prevented.

In order to achieve the above object, according to an embodiment of the present invention, a fastening tape for a seat pad, which is connected integrally to the seat pad when urethane is foamed to form the seat pad in order to attach a seat cover to an outside of the seat pad, includes: a holding sheet on one side of which a plurality of hooks to be connected to loops that are provided inside the seat cover are formed, for attaching the seat cover to an outside of the seat pad; and a connection member to be connected to the other side of the holding sheet for connecting the holding sheet to the seat pad, wherein the connection member includes a connection portion that is connected to the holding sheet and provided with a plurality of ring portions, and a mesh portion that is connected to the ring portion, such that a gas produced when urethane is foamed to form the seat pad is discharged through the mesh portion and the ring portion thereby to prevent or minimize a gap produced between the connection member and the seat pad by the gas.

The connection member is made of polyester.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 is a perspective view showing a fastening tape for a seat pad according to an embodiment of the present invention;

FIG. 2 is a cross-sectional view showing a fastening tape for a seat pad according to an embodiment of the present invention;

FIG. 3 is a cross-sectional view showing a fastening tape for a seat pad, which is attached to the seat pad, according to an embodiment of the present invention;

FIG. 4 is a cross-sectional view showing a seat cover that is attached to a seat pad provided with a fastening tape for a seat pad according to an embodiment of the present invention;

FIG. 5 is a cross-sectional view showing a mold for forming a seat pad provided with a fastening tape for a seat pad according to an embodiment of the present invention; and

FIG. 6 is a perspective view showing a seat cover that is attached to a seat pad of a chair for a vehicle.

### DETAILED DESCRIPTION OF THE PREFERRED EMBODIMENTS

Hereinafter, exemplary embodiments of the present invention are described in detail with reference to the accompanying drawings. In the description, a thickness of lines indicated in the drawings and sizes of the components may be exaggerated for clarity and convenience thereof.

Further, the terms in the followings are defined in considering of functions in the present invention and they may be different a little in accordance with the intentions of a user, an operator or a practice. Accordingly, they have to be defined based on the entire description of the specification and claims of the present invention.

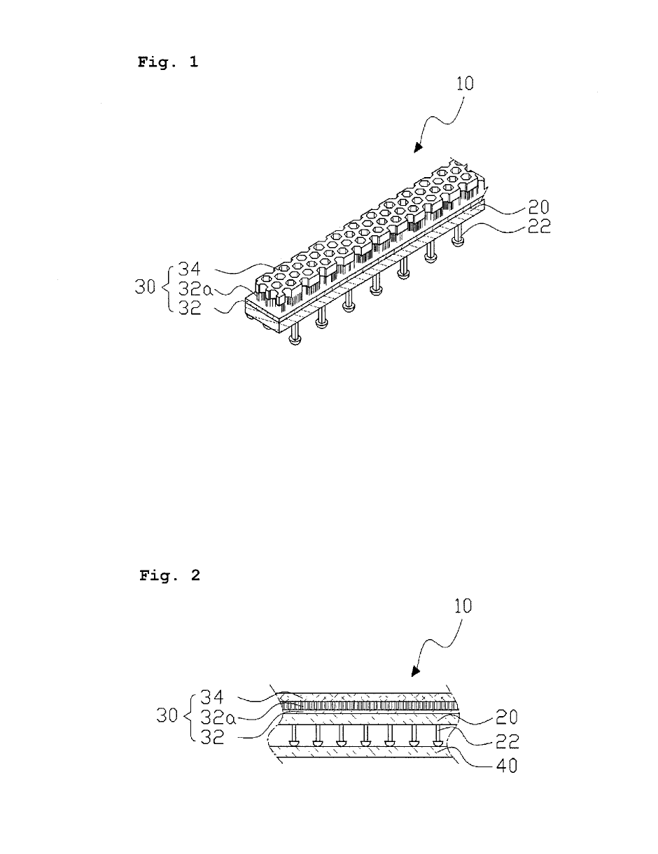

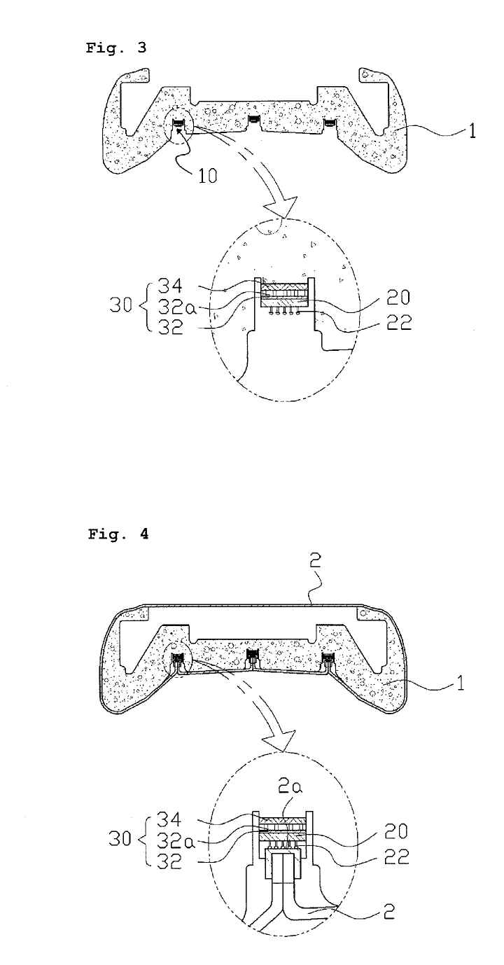

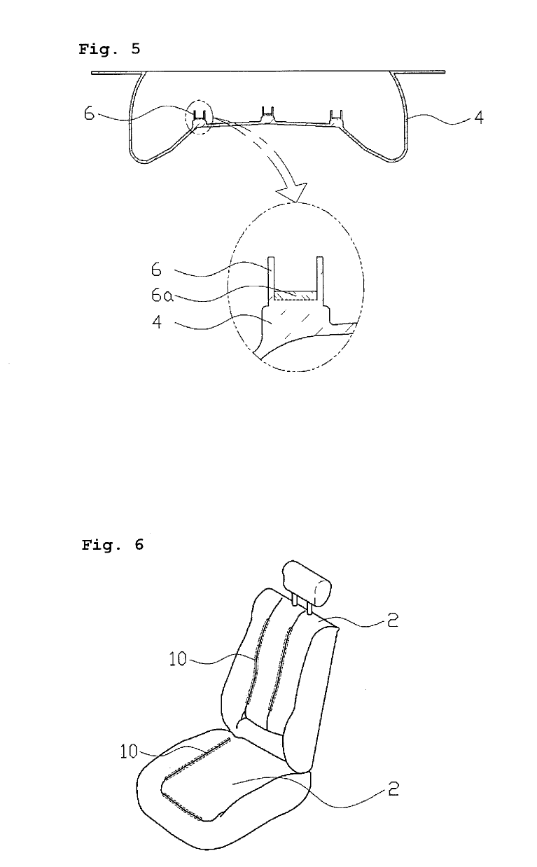

FIG. 1 is a perspective view showing a fastening tape for a seat pad according to an embodiment of the present invention, FIG. 2 is a cross-sectional view showing a fastening tape for a seat pad according to an embodiment of the present invention, FIG. 3 is a cross-sectional view showing a fastening tape for a seat pad, which is attached to the seat pad, according to an embodiment of the present invention, FIG. 4 is a cross-sectional view showing a seat cover that is attached to a seat pad provided with a fastening tape for a seat pad according to an embodiment of the present invention, FIG. 5 is a cross-sectional view showing a mold for forming a seat pad provided with a fastening tape for a seat pad according to an embodiment of the present invention, and FIG. 6 is a perspective view showing a seat cover that is attached to a seat pad of a chair for a vehicle.

Referring to FIGS. 1 to 6, a fastening tape 10 for a seat pad includes a holding sheet 20 and connection members 30.

The fastening tape 10 for a seat pad is used for attaching a seat cover 2 to an outside of a seat pad 1 having a cushion.

A plurality of hooks 22 are provided on one side of the holding sheet 20 wherein the hooks are connected to a loop 2a that is attached on an inside of the seat cover 2, when the seat cover 2 is covered over the seat pad 1, allowing for the seat cover 2 to be attached to the seat pad 1.

Here, the hook 22 may be formed with various shapes including a hook shape or a anchor shape, etc., if necessary.

The connection member 30 is connected to the other side of the holding sheet 20, allowing for the fastening tape 10 to be attached firmly to the seat pad 1 when urethane resin is introduced and foamed in a mold 4 to form the seat pad 1.

Here, the connection member 30 may be connected firmly to the holding sheet 20 with hot melt or using a bonding agent.

The connection member 30 is connected to the other side of the holding sheet 20 wherein the connection member 30 includes a connection portion 32 on which a plurality of ring portions 32a are formed at an opposite side to a surface of the fastening tape 10 to which the holding sheet 20 is connected, and a mesh portion 34 that is connected to the ring portion 32a.

Meanwhile, a method of attaching a fastening tape 10 for a seat pad, as configured above, to the seat pad 1 is configured such that the fastening tape 10 is arranged in a fixing frame 6 provided on a mold 4 for forming the seat pad, and urethane resin is introduced and foam-formed in the mold 4 for forming the seat pad. At this time, the urethane resin passes through the mesh portion 34 of the connection member 30 and then permeates to the ring portion 32a formed on the connection portion 32 so that the connection member 30 is connected to the seat pad 1 that is foam-formed in the mold 4 for forming the seat pad. As a result, the seat pad 1 with the fastening tape 10 being connected thereto is manufactured.

At this time, a gas is to be produced when urethane resin is introduced and foamed in the mold 4 for forming the seat pad in order to form the seat pad 1 and the gas is to be discharged outside through the mesh portion 34 and the ring portion 32a of the connection member 30, and thus the gas does not remain between the connection member 30 and the seat pad 1 when the seat pad 1 provided with the fastening tape 10 completes to be formed, thereby to minimize a gap that is produced between the connection member 30 and the seat pad 1 by the gas to increase an bonding force between the fastening tape 10 and the seat pad 1.

Here, a cover 40 containing iron powder is attached on a surface of a hook 22 formed on one side of the holding sheet 20 of the fastening tape 10 and a permanent magnet 6a is provided on a lower part of the fixing frame 6 such that the fastening tape 10 is to be in close contact with the fixing frame 6 by magnetic force when the fastening tape 10 is provided in the fixing frame 6, thereby preventing the fastening tape 10 from being separated or twisted when the seat pad 1 is formed.

According to the present invention, a fastening tape is bonded to a seat pad to attach a seat cover to the seat pad wherein a decreasing of a bonding force between the seat pad and the fastening tape, which is caused from a gap that is formed therebetween by a gas produced when a urethane resin is introduced and foam-formed, can be prevented.

Although the present invention was described above with reference to the exemplary embodiments stated above, those skilled in the art can easily recognize that the present invention may be changed and modified in various ways without departing from the spirit and scope of the present invention and it is apparent that the changes and modifications are all included in claims.

What is claimed is:

1. A fastening tape for a seat pad, which is connected integrally to the seat pad when urethane is foamed to form the seat pad in order to attach a seat cover to an outside of the seat pad comprising:
a holding sheet on one side of which a plurality of hooks to be connected to loops that are provided inside the seat cover are formed, for attaching the seat cover to an outside of the seat pad; and
a connection member to be connected to the other side of the holding sheet for connecting the holding sheet to the seat pad, wherein the connection member comprises a connection portion that is connected to the holding sheet and provided with a plurality of ring portions, and a mesh portion that is connected to the ring portion, such that a gas produced when urethane is foamed to form the seat pad is discharged through the mesh portion and the ring portion thereby to prevent or minimize a gap produced between the connection member and the seat pad by the gas.

2. The fastening tape for a seat pad of claim 1, wherein the connection member is made of polyester.

3. A seat pad provided with the fastening tape of claim 1.

4. A seat pad provided with the fastening tape of claim 2.
